(19) United States
(12) Patent Application Publication
(10) Pub. No.: US 2026/0254575 A1
(43) Pub. Date: Aug. 27, 2026

(54) DATA TRANSMISSION METHOD AND APPARATUS, ELECTRONIC DEVICE, AND COMPUTER READABLE STORAGE MEDIUM

(71) Applicant: CHINA TELECOM CORPORATION LIMITED, Beijing (CN)

(72) Inventors: Nanxi LI, Beijing (CN); Jianchi ZHU, Beijing (CN); Jing GUO, Beijing (CN); Hang YIN, Beijing (CN); Xiaoming SHE, Beijing (CN)

(21) Appl. No.: 19/477,270

(22) PCT Filed: Jul. 21, 2022
(86) PCT No.: PCT/CN2022/107181

§ 371 Date: Dec. 22, 2025

(30) Foreign Application Priority Data
Sep. 23, 2021 (CN) 202111125785.1

(51) Int. Cl. H04L 5/00; H04W 72/044

(52) U.S. Cl. CPC H04L 5/0012; H04W 72/044

(57) ABSTRACT

The present disclosure provides a data transmission method and apparatus, an electronic device, and a computer readable storage medium. The method comprises: determining time domain resource configuration information when a target device repeatedly transmits uplink information, and frequency domain resource configuration information for frequency hopping; determining, according to the time domain resource configuration information, a plurality of corresponding slots when the target device repeatedly transmits the uplink information; determining at least one group of binding slots among the plurality of slots, each group of binding slots comprising at least one slot; and determining, according to the at least one group of binding slots, time domain position information for frequency hopping, so that the target device performs frequency hopping transmission on the binding slots for uplink information according to the time domain position information for frequency hopping and the frequency domain resource configuration information for frequency hopping.

The present application is a U.S. National Stage Application of International Application No. PCT/CN2022/107181, filed on Jul. 21, 2022, which is claims the benefit of and priority to Chinese Patent Application No. 202111125785.1, entitled “DATA TRANSMISSION METHOD AND APPARATUS, ELECTRONIC DEVICE AND COMPUTER-READABLE STORAGE MEDIUM,” filed on Sep. 23, 2021, the entire contents of both of which are hereby incorporated by reference.

### TECHNICAL FIELD

The present disclosure relates to the field of communication technologies and, in particular, to a data transmission method and apparatus, an electronic device, and a computer-readable storage medium.

### BACKGROUND

To improve data transmission reliability, New Radio (NR) systems in fifth-generation (5G) mobile communication systems support multiple repetition transmissions of data. In scenarios involving such multiple repetitions, NR systems support frequency-hopping transmission. Frequency-hopping transmission is an important research topic in communication technologies.

It should be noted that the information disclosed in the Background section above is only for enhancing the understanding of the background of the present disclosure, and thus may include information that does not constitute prior art known to those of ordinary skill in the art.

### SUMMARY

Embodiments of the present disclosure provide a data transmission method, which includes: determining time domain resource configuration information and frequency domain resource configuration information for frequency hopping for uplink information repetition transmission of a target device; determining a plurality of slots corresponding to the uplink information repetition transmission of the target device based on the time domain resource configuration information; determining at least one bundling slot group from the plurality of slots, wherein each bundling slot group comprises at least one slot; and determining time domain position information for frequency hopping according to the at least one bundling slot group, to perform, by the target device, frequency hopping transmission with bundling slot of the uplink information based on the time domain position information for frequency hopping and the frequency domain resource configuration information for frequency hopping.

Embodiments of the present disclosure provide an electronic device, which includes: one or more processors; and a storage device configured to store one or more programs, which, when executed by the one or more processors, cause the one or more processors to implement the data transmission method as described in any of the preceding embodiments.

Embodiments of the present disclosure provide a computer-readable storage medium having a computer program stored thereon, wherein the computer program, when executed by a processor, implements the data transmission method as described in any of the preceding embodiments.

It should be noted that the above general description and the following detailed description are merely exemplary and explanatory and should not be construed as limiting of the present disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure. Apparently, the drawings in the following description are only some embodiments of the present disclosure. For those of ordinary skill in the art, other drawings may be obtained based on these drawings without paying any creative effort.

FIG. 1 shows a flowchart of a data transmission method according to an example embodiment.

FIG. 2 shows a method for determining a bundling slot according to an example embodiment.

FIG. 3 shows a schematic diagram of determining a bundling slot according to an example embodiment.

FIG. 4 shows a schematic diagram of determining a bundling slot according to an example embodiment.

FIG. 5 shows a schematic diagram of determining a bundling slot according to an example embodiment.

FIG. 6 shows a flowchart of a method for determining a bundling slot according to an example embodiment.

FIG. 7 shows a flowchart of a method for determining a bundling slot according to an example embodiment.

FIG. 8 shows a flowchart of a method for determining a bundling slot according to an example embodiment.

FIG. 9 shows a flowchart of a method for determining a bundling slot according to an example embodiment.

FIG. 10 shows a flowchart of a method for signal parsing and processing according to an example embodiment.

FIG. 11 shows a flowchart of a method for signal parsing and processing according to an example embodiment.

FIG. 12 shows a flowchart of a frequency hopping transmission method according to an example embodiment.

FIG. 13 shows a block diagram of a data transmission apparatus according to an example embodiment.

FIG. 14 shows a schematic structural diagram of an electronic device suitable for implementing embodiments of the present disclosure.

### DETAILED DESCRIPTION

Example embodiments will now be described more fully with reference to the accompanying drawings. However, the example embodiments can be implemented in a variety of forms and should not be construed as being limited to examples set forth herein; rather, these embodiments are provided so that the present disclosure will be more complete and comprehensive so as to convey the idea of the example embodiments to those skilled in this art. The same reference numerals in the drawings denote the same or similar parts, and the repeated description thereof will be omitted.

The features, structures, or characteristics described in the present disclosure may be combined in any suitable manner in one or more embodiments. In the following description, numerous specific details are set forth to provide a thorough understanding of the embodiments of the present disclosure. However, those skilled in the art will appreciate that the technical solution of the present disclosure may be practiced without one or more of the specific details, or other methods, components, apparatuses, steps and the like may be employed. In other instances, well-known methods, apparatuses, implementations or operations are not shown or described in detail to avoid obscuring various aspects of the present disclosure.

The drawings are merely schematic representations of the present disclosure, and the same reference numerals in the drawings denote the same or similar parts, and the repeated description thereof will be omitted. Some of the block diagrams shown in the figures do not necessarily correspond to physically or logically separate entities. These functional entities may be implemented in software, or implemented in one or more hardware modules or integrated circuits, or implemented in different networks and/or processor devices and/or microcontroller devices.

The flowchart shown in the accompanying drawings is merely illustrative and does not necessarily include all content and steps, nor does it require execution in the described order. For example, some steps may be broken down, while others may be combined or partially combined. Therefore, the actual execution order may change depending on the specific circumstances.

In the present specification, the terms “one”, “a”, “the”, “said”, and “at least one” are used to indicate that there are one or more elements/components or the like; the terms “include”, “contain” and “have” are used to indicate an open meaning of including and means that there may be additional elements/components/etc. in addition to the listed elements/components/etc.; and the terms “first”, “second” and “third” etc. are used only as markers, and do not limit the number of objects.

To better understand the above-mentioned objectives, features and advantages of the present disclosure, the present disclosure will be further described in detail below with reference to the accompanying drawings and specific embodiments. It should be noted that, unless otherwise conflicting, embodiments and features in the embodiments of the present disclosure can be combined with each other.

In some embodiments, before the execution of the scheme of the present disclosure, a target network device may configure a target device with time-frequency transmission resources for uplink information repetition transmission and frequency domain resource position information for frequency hopping transmission.

In some embodiments, the target network device may indicate to the target device through control information to perform frequency hopping transmission with bundling slot.

The target network device can be a base station in a mobile network.

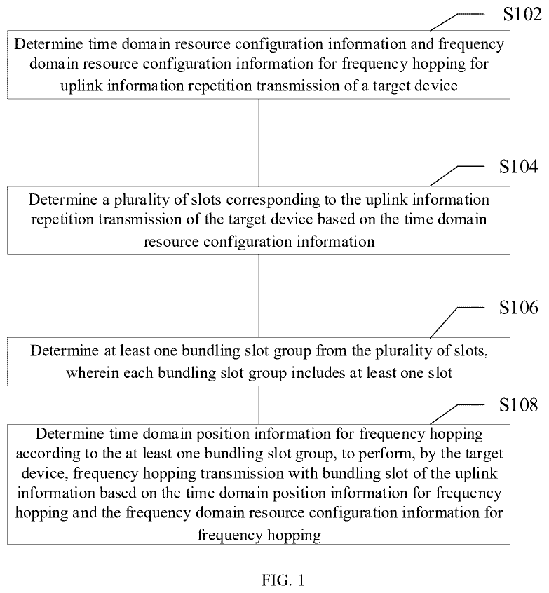

In some embodiments, when the target device receives the indication of frequency hopping transmission with bundling slot from the target network device, it performs steps shown in FIG. 1.

FIG. 1 shows a flowchart of a data transmission method according to an example embodiment. The method provided in embodiments of the present disclosure can be executed by a target device or by a target network device corresponding to the target device. In the following embodiments, the target device is used as the execution subject for illustrative purposes, but the present disclosure is not limited thereto.

The target device can be any electronic device capable of communication, including but not limited to smartphones, tablets, laptops, desktop computers, wearable devices, virtual reality devices, smart home devices, etc.

Referring to FIG. 1, the data transmission method provided in embodiments of the present disclosure may include steps S102 to S108.

In the step S102, time domain resource configuration information and frequency domain resource configuration information for frequency hopping (or referred as to frequency domain resource configuration information of frequency hopping or frequency domain resource configuration information with frequency hopping) for uplink information repetition transmission of a target device are determined.

In some embodiments, the target device may receive the time domain resource configuration information and the frequency domain resource configuration information for frequency hopping for the uplink information repetition transmission from the target network device.

In the step S104, a plurality of slots corresponding to the uplink information repetition transmission of the target device are determined based on the time domain resource configuration information.

In some embodiments, the plurality of slots corresponding to the uplink information repetition transmission of the target device can be determined based on the time domain resource configuration information. For example, 8 slots corresponding to the uplink information repetition transmission of the target device can be determined, or 10 slots corresponding to the uplink information repetition transmission of the target device can be determined, or 12 slots corresponding to the uplink information repetition transmission of the target device can be determined. The present disclosure does not limit the number of slots corresponding to the uplink information repetition transmission.

In the step S106, at least one bundling slot group is determined from the plurality of slots, and each bundling slot group includes at least one slot.

In some embodiments, the at least one bundling slot group can be determined from the plurality of slots according to control information sent by the target network device. The control information sent by the target network device includes time domain window determination information, bundling slot configuration information, or other control information transmitted by the target network device, which is not limited by the present disclosure.

That is, the target device can bundle the plurality of slots according to the bundling slot configuration information sent by the target network device. The target device can also reuse other configuration information sent by the target network device (e.g., time domain window configuration information that can be used to determine a time domain window from a plurality of slots) to bundle the plurality of slots.

The so-called “time domain window” may mean that the target network device expects the target device to maintain phase consistency and power consistency when performing the uplink information repetition transmission in this time domain window, thereby enabling the target network device to perform joint channel estimation for the uplink transmission information received within the time domain window.

In the step S108, time domain position information for frequency hopping is determined according to the at least one bundling slot group, to perform, by the target device, frequency hopping transmission with bundling slot of the uplink information based on the time domain position information for frequency hopping and the frequency domain resource configuration information for frequency hopping.

The uplink information can be uplink data information or uplink control information, where the uplink data information is carried by Physical Uplink Shared Channel (PUSCH), and the uplink control information is carried by Physical Uplink Control Channel (PUCCH) or PUSCH.

In some embodiments, a position of a first slot of each bundling slot group can be used as the time domain position information for frequency hopping, a middle position of each bundling slot group can also be used as the time domain position information for frequency hopping, and a position of the last slot of each bundling slot group can also be used as the time domain position information for frequency hopping, which is not limited by the present disclosure.

The position of the first slot of each bundling slot group can refer to a starting position (i.e., a first slot within the bundling slots that can be used for effective uplink transmission of the uplink information) of a valid uplink slot of each bundling slot group as the time domain position information for frequency hopping.

The following explanation will use the example of a target bundling slot group of the at least one bundling slot group including two slot groups to illustrate the starting position of the valid uplink slot. However, it can be understood that the target bundling slot group may include at least one slot, such as 1 slot, 2 slots, 3 slots or 4 slots, etc., which is not limited by the present disclosure.

In some embodiments, the at least one bundling slot group includes the target bundling slot group. The target bundling slot group may include a first target slot and a second target slot, the first target slot may be a first slot in the target bundling slot group, and the second target slot may be the next slot after the first target slot. If the first target slot is not used for the uplink transmission of the uplink information, then the target network device can determine the second target slot as the starting position of the valid uplink slot of the target bundling slot group, that is, the target device will start frequency hopping transmission from the second target slot.

It can be understood that the first target slot may not be able to be used for the uplink transmission of this uplink information, but may be able to be used for the uplink transmission of other uplink information, which is not limited by the present disclosure.

It can be understood that those skilled in the art can extend the above embodiments to include 3, 4, 5 . . . slots in the target bundling slot, and can also extend them to scenarios where there are multiple uplink transmissions not used for the uplink information at the starting position of the target bundling slot, which is not limited by the present disclosure.

In some embodiments, if the target bundling slot group includes only one slot and this slot is not used for uplink transmission of uplink information, it can be determined that the target bundling slot group does not include the starting position of the valid uplink slot, and the frequency hopping transmission with bundling slot is not performed through the target bundling slot group.

In some embodiments, the target device can perform the frequency hopping transmission with bundling slot according to the frequency domain resource configuration information for frequency hopping and the at least one bundling slot group. Each bundling slot group corresponds to frequency domain resource configuration information of a frequency hopping, and the time domain position for the frequency hopping is the starting position of the valid uplink slot of each bundling slot group. The target device maintains phase consistency and power consistency within each time domain window when performing the frequency hopping transmission with bundling slot. The time domain window may refer to a time domain window configured by the target network device for the target device, so that the target device maintains phase consistency and power consistency when performing uplink transmission within each time domain window.

The following illustrates the frequency hopping transmission with bundling slot process by taking the at least one bundling slot group including two bundling slot groups and the frequency domain resource configuration information for frequency hopping including two frequency domain resource configuration information as an example. However, it should be noted that the at least one bundling slot group may include any number of bundling slot groups, such as 1, 3, 4, or 5, which is not limited by the present disclosure.

In some embodiments, the at least one bundling slot group includes a first bundling slot group and a second bundling slot group, and the frequency domain resource configuration information for frequency hopping includes first frequency domain resource configuration information and second frequency domain resource configuration information. Then, performing, by the target device, the frequency hopping transmission with bundling slot according to the frequency domain resource configuration information for frequency hopping and the at least one bundling slot group may include the following steps: the target device performs uplink information transmission in the first bundling slot group according to the first frequency domain resource configuration information; and the target device performs the uplink information transmission in the second bundling slot group according to the second frequency domain resource configuration information.

In some embodiments, the at least one bundling slot group further includes a third bundling slot group, and the frequency domain resource configuration information for frequency hopping further includes third frequency domain resource configuration information. Then, performing, by the target device, the frequency hopping transmission with bundling slot according to the frequency domain resource configuration information for frequency hopping and the at least one bundling slot group may further include: the target device performs the uplink information transmission in the third bundling slot group according to the third frequency domain resource configuration information.

It can be understood that those skilled in the art can make appropriate extensions based on the above embodiments. For example, 4 (5, 6 . . . ) bundling slot groups can be matched with 4 (5, 6 . . . ) frequency domain resource configuration information and corresponding frequency hopping transmission can be performed, which is not repeated by the present disclosure.

In the technical solution provided in the embodiment, the plurality of slots corresponding to the uplink information are bundled, and then the frequency hopping transmission is performed for each bundling slot group, which allows the frequency hopping transmission to be combined with the joint channel estimation technology, thereby improving the uplink transmission performance.

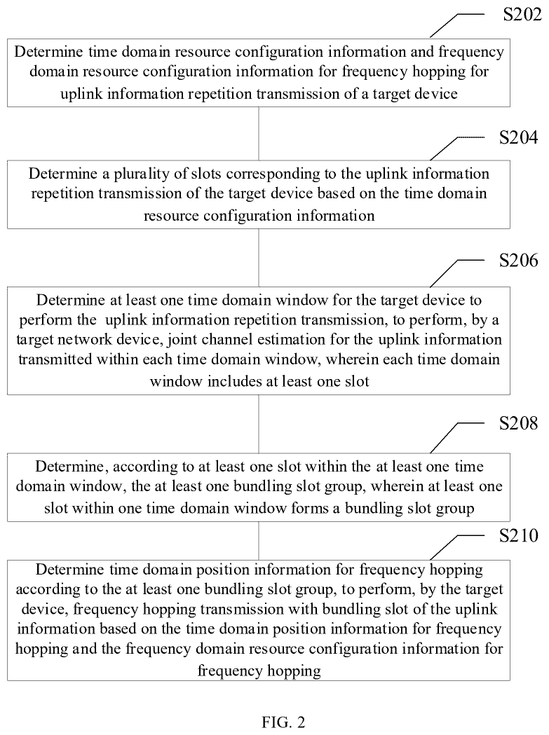

FIG. 2 shows a method for determining a bundling slot according to an example embodiment. Referring to FIG. 2, the method for determining the bundling slot may include steps S202 to S210.

In the step S202, time domain resource configuration information for uplink information repetition transmission by a target device and frequency domain resource configuration information for frequency hopping are determined.

In the step S204, a plurality of slots corresponding to the uplink information repetition transmission of the target device are determined according to the time domain resource configuration information.

In the step S206, at least one time domain window for the target device to perform the uplink information repetition transmission is determined, so that the target network device can perform joint channel estimation for the uplink information transmitted within each time domain window, and each time domain window includes at least one slot.

In some embodiments, the target network device may send time domain window configuration information to the target device, so that the target device can determine the at least one time domain window according to the time domain window configuration information. When the target device performs the uplink information repetition transmission, it can maintain phase consistency and power consistency within each time domain window, so that the target network device can perform joint channel estimation within each time domain window.

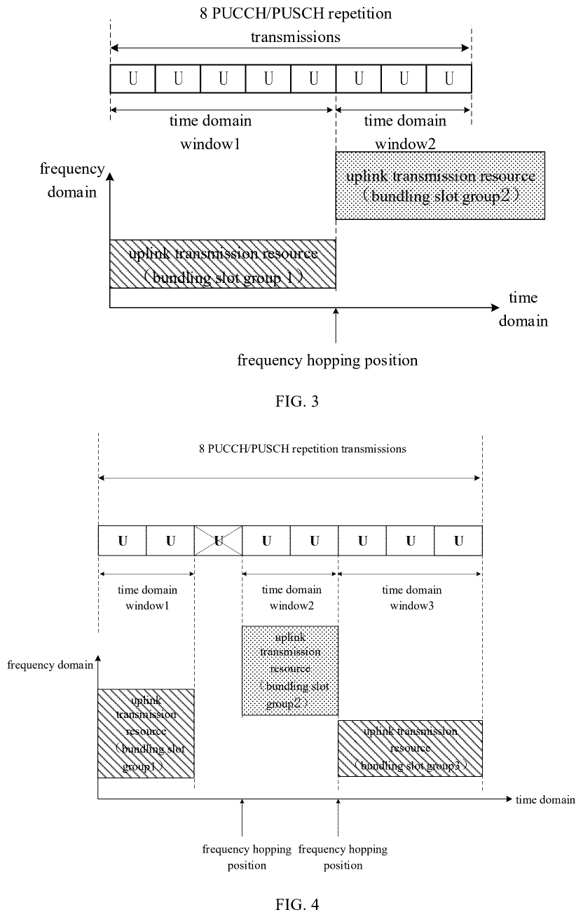

As shown in FIG. 3, the target device can determine, according to the time domain window configuration information sent by the target network device, two time domain windows from the plurality of slots (e.g., 8 slots) corresponding to the uplink information repetition transmission.

As shown in FIG. 3, in a Frequency Division Duplexing (FDD) system, the target device can determine time domain window 1 and time domain window 2 based on the time domain window configuration information sent by the target network device, and the target terminal maintains phase consistency and power consistency when transmitting uplink information within two windows, respectively. The target network device implicitly indicates the time domain position for frequency hopping (i.e., it no longer sends additional control information to indicate the frequency hopping position, and the time domain position for frequency hopping can be determined based on the time domain window). The lengths of the bundling slots are equal to lengths of individual time domain windows, respectively, and the frequency hopping position is the starting position of the valid uplink slot within each time domain window.

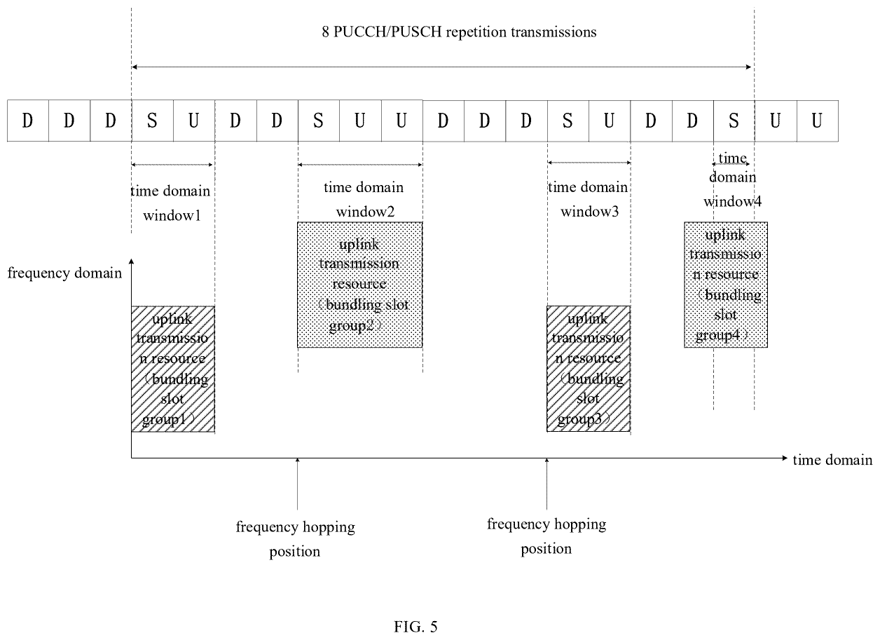

As shown in FIG. 4, in the FDD system, the target device can determine time domain window 1, time domain window 2, and time domain window 3 based on the time domain window configuration information sent by the target network device, and the target device maintains phase consistency and power consistency within the three windows, respectively. The network device implicitly indicates the time domain position for frequency hopping (i.e., it no longer sends additional control information to indicate the frequency hopping position, and the time domain position for frequency hopping can be determined based on the time domain window). The lengths of the bundling slots are equal to lengths of individual time domain windows, respectively, and the time domain position for frequency hopping is the starting position of the valid uplink slot within each time domain window.

As shown in FIG. 5, in a Time Division Duplex (TDD) system, taking a 2.5 ms dual-period frame structure of “DDDSUDDSUU” as an example, the target device can determine time domain window 1, time domain window 2, time domain window 3, and time domain window 4 based on the time domain window configuration information sent by the target network device, and the target device maintains phase consistency and power consistency when transmitting information within the four windows, respectively. The network device implicitly indicates the time domain position for frequency hopping (i.e., it no longer sends additional control information to indicate the frequency hopping position, and the time domain position for frequency hopping can be determined based on the time domain window). The lengths of the bundling slots are equal to lengths of individual time domain windows, respectively, and the time domain position for frequency hopping is the starting position of the valid uplink slot within each time domain window.

In the step S208, at least one bundling slot group is determined according to at least one slot within the at least one time domain window, and at least one slot within one time domain window forms a bundling slot group.

In some embodiments, the at least one slot within each time domain window can be directly used as a bundling slot group.

As shown in FIG. 3, the target network device implicitly indicates the time domain position for frequency hopping (i.e., it no longer sends additional control information to indicate the frequency hopping position, and the time domain position for frequency hopping can be determined based on the time domain window). The lengths of the bundling slots are equal to lengths of individual time domain windows, respectively, and the time domain position for frequency hopping is the starting position of the valid uplink slot within each time domain window. For example, in FIG. 3, all slots within time domain window 1 can be considered as bundling slot group 1, and all slots within time domain window 2 can be considered as bundling slot group 2. A first valid uplink slot of bundling slot group 2 is then used as the frequency hopping position.

As shown in FIG. 4, in the FDD system, the target device can determine time domain window 1, time domain window 2, and time domain window 3 based on the time domain window configuration information sent by the target network device, and the target device maintains phase consistency and power consistency within the three windows, respectively. The network device implicitly indicates the time domain position for frequency hopping (i.e., it no longer sends additional control information to indicate the frequency hopping position, and the time domain position for frequency hopping can be determined based on the time domain window). The lengths of the bundling slots are equal to lengths of individual time domain windows, respectively, and the time domain position for frequency hopping is the starting position of the valid uplink slot within each time domain window.

For example, in FIG. 4, all slots within time domain window 1 can be used as bundling slot group 1, all slots within time domain window 2 can be used as bundling slot group 2, and all slots within time domain window 3 can be used as bundling slot group 3. The first valid uplink slot in bundling slot group 2 can be used as a first time domain frequency hopping position, and the first valid uplink slot in bundling slot group 3 can be used as the second time domain frequency hopping position.

As shown in FIG. 5, in a Time Division Duplex (TDD) system, taking a 2.5 ms dual-period frame structure of “DDDSUDDSUU” as an example, the target device can determine time domain window 1, time domain window 2, time domain window 3, and time domain window 4 based on the time domain window configuration information sent by the target network device, and the target device maintains phase consistency and power consistency when transmitting information within the four windows, respectively. The network device implicitly indicates the frequency hopping position (i.e., it no longer sends additional control information to indicate the frequency hopping position, and the time domain position for frequency hopping can be determined based on the time domain window). The lengths of the bundling slots are equal to lengths of individual time domain windows, respectively, and the time domain position for frequency hopping is the starting position of the valid uplink slot within each time domain window.

For example, in FIG. 5, all slots within time domain window 1 can be used as bundling slot group 1, all slots within time domain window 2 can be used as bundling slot group 2, all slots within time domain window 3 can be used as bundling slot group 3, and all slots within time domain window 4 can be used as bundling slot group 4. The first valid uplink slot in bundling slot group 2 is used as the first time domain frequency hopping position, the first valid uplink slot in bundling slot group 3 is used as the second time domain frequency hopping position, and the first valid uplink slot in bundling slot group 4 is used as the third time domain frequency hopping position.

The above embodiments illustrate the applicability of the frequency hopping transmission with bundling slot method in the present disclosure to both FDD and TDD systems. Furthermore, the present disclosure is not limited by the number of frequency hopping positions. The above embodiments only exemplify the case with a maximum of two frequency hopping positions, but the present disclosure can also be applicable for cases with more than two frequency hopping positions.

In the step S210, time domain position information for frequency hopping is determined according to the at least one bundling slot group, so that the target device performs frequency hopping transmission with bundling slot of the uplink information according to the time domain position information for frequency hopping and the frequency domain resource configuration information for frequency hopping.

In some embodiments, performing, by the target device, the frequency hopping transmission with bundling slot of uplink information based on the time domain position information for frequency hopping and the frequency domain resource configuration information for frequency hopping includes: the target device performs the frequency hopping transmission with bundling slot based on the frequency domain resource configuration information for frequency hopping and the at least one bundling slot group, each bundling slot group corresponds to frequency domain resource configuration information of a frequency hopping, and the time domain position for frequency hopping is the starting position of the valid uplink slot of each bundling slot group. The target device maintains phase consistency and power consistency within each time domain window when performing the frequency hopping transmission with bundling slot.

In some embodiments, the at least one bundling slot group includes a target bundling slot group, which includes a first target slot and a second target slot. The first target slot is a first slot in the target bundling slot group, and the second target slot is the next slot after the first target slot. The first target slot is not used for uplink transmission of uplink information. Then the target device can determine the second target slot as the starting position of the valid uplink slot of the target bundling slot group.

As shown in FIG. 3, the starting position (i.e., the first slot within time domain window 2) of the first valid uplink slot in bundling slot group 2 can be used as the frequency hopping position.

As shown in FIG. 4, the starting position (i.e., the first slot within time domain window 2) of the first valid uplink slot in bundling slot group 2 can be used as the frequency hopping position of the second bundling slot group, and the starting position (i.e., the second slot within time domain window 3) of the first valid uplink slot in the third bundling slot group (time domain window) can be used as the frequency hopping position.

In some embodiments, at least one bundling slot group includes a first bundling slot group (bundling slot group 1 corresponding to time domain window 1 in FIG. 4) and a second bundling slot group (bundling slot group 2 corresponding to time domain window 2 in FIG. 4), and the frequency domain resource configuration information for frequency hopping includes first frequency domain resource configuration information and second frequency domain resource configuration information. Performing, by the target device, the frequency hopping transmission with bundling slot according to the frequency domain resource configuration information for frequency hopping and the at least one bundling slot group includes: the target device performs uplink information transmission in the first bundling slot group according to the first frequency domain resource configuration information (i.e., uplink transmission is performed using the first frequency domain resource configuration information in bundling slot group 1 in FIG. 4), and the target device performs uplink information transmission in the second bundling slot group according to the second frequency domain resource configuration information (i.e., uplink transmission is performed using the second frequency domain resource configuration information in bundling slot group 2 in FIG. 4).

In some embodiments, the at least one bundling slot group further includes a third bundling slot group (bundling slot group 3 corresponding to time domain window 3 in FIG. 4), and the frequency domain resource configuration information for frequency hopping further includes third frequency domain resource configuration information. Then the target device can also perform uplink information transmission in the third bundling slot group according to the third frequency domain resource configuration information (that is, uplink transmission is performed using the third frequency domain resource configuration information in bundling slot group 3 in FIG. 4).

In the technical solution provided in the embodiment, the at least one bundling slot group is implicitly determined through the time domain window during the uplink information repetition transmission, so as to perform frequency hopping transmission with bundling slot within each time domain window. Through this method, on the one hand, the bundling slot is determined through implicit indication without additional control information, and a method for determining the time domain window can be directly reused to determine the at least one bundling slot group. On the other hand, the slot bundling is performed in combination with the time domain window, and the target network device can perform joint channel estimation for the slots within the time domain window, thereby improving uplink transmission performance.

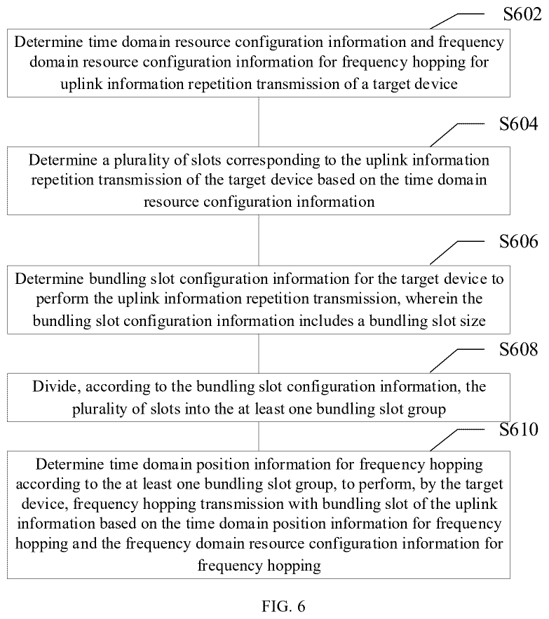

FIG. 6 shows a flowchart of a method for determining a bundling slot according to an example embodiment. Referring to FIG. 6, the method for determining the bundling slot may include steps S602 to S610.

In the step S602, time domain resource configuration information for uplink information repetition transmission by a target device and frequency domain resource configuration information for frequency hopping are determined.

In the step S604, a plurality of slots corresponding to the uplink information repetition transmission of the target device are determined according to the time domain resource configuration information.

In the step S606, a bundling slot configuration for the target device to perform the uplink information repetition transmission is determined, and the bundling slot configuration information includes a bundling slot size.

In some embodiments, the bundling slot size may refer to the number of physical slots, the number of uplink slots, or a time cycle. The physical slots may include uplink slots and downlink slots.

In the step S608, the plurality of slots are divided into at least one bundling slot group according to the bundling slot configuration information.

In some embodiments, the plurality of slots can be divided into the at least one bundling slot group based on the bundling slot configuration information (e.g., the bundling slot size). For example, the plurality of slots can be divided into the at least one bundling slot group based on the number of physical slots, or based on the number of uplink slots, or based on the time cycle.

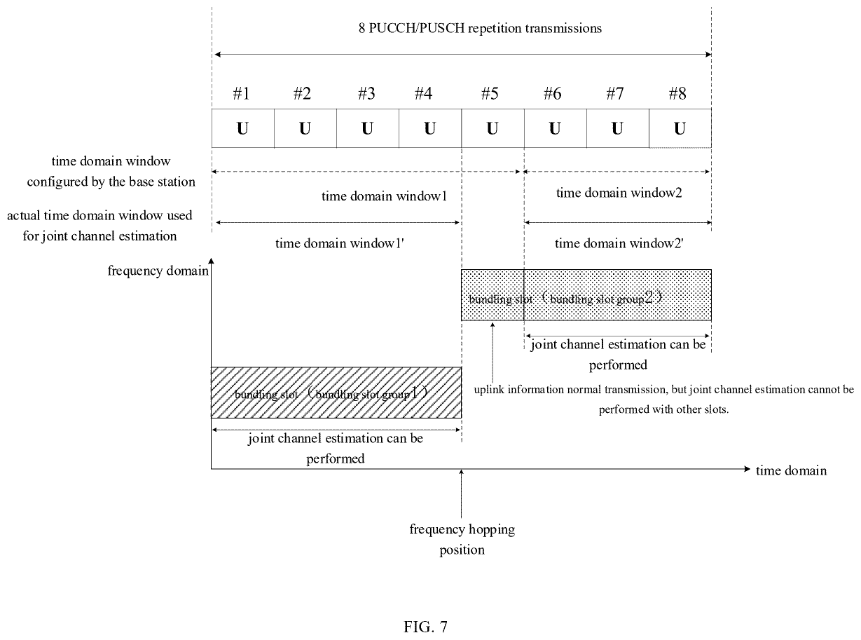

As shown in FIG. 7, in the FDD system, the target device can determine time domain window 1 and time domain window 2 from the plurality of slots based on the time domain window configuration information sent by the target network device, and the target device maintains phase consistency and power consistency within two windows, respectively. The target network device explicitly configures the number of slots in the bundling slot group (i.e., the target network device informs the target device of the size (e.g., the number of bundling slots or the time cycle of the bundling slots) of the bundling slots in each slot group by sending the control information), such as 4 physical slots. The target device can divide, based on the slot size (e.g., the size of 4 physical slots) sent by the target network device, at least one bundling slot group (bundling slot group 1 and bundling slot group 2 in FIG. 7) from the plurality of slots corresponding to the uplink information.

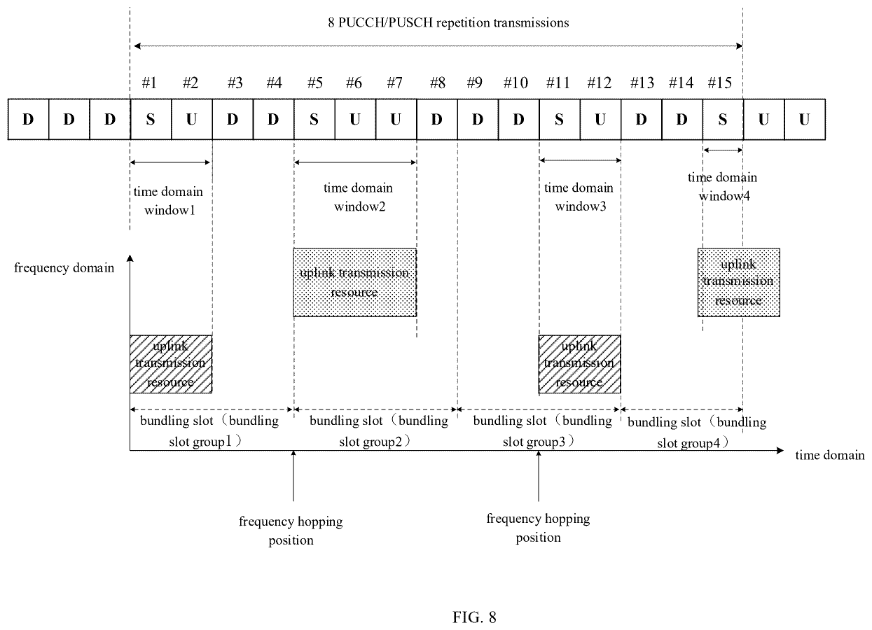

As shown in FIG. 8, in the TDD system, taking a 2.5 ms dual-period frame structure of “DDDSUDDSUU” as an example, the target device can determine time domain window 1, time domain window 2, time domain window 3, and time domain window 4 based on the time domain window configuration information sent by the target network device, and the target device maintains phase consistency and power consistency within four windows, respectively. The network device explicitly configures the number of bundling slots (i.e., the target network device informs the target device of the size (e.g., the number of bundling slots or the time cycle of the bundling slots) of the bundling slots in each slot group by sending the control information), such as 4 physical slots. The target device can divide, based on the slot size (e.g., the size of 4 physical slots) sent by the target network device, at least one bundling slot group (bundling slot group 1, bundling slot group 2, bundling slot group 3, and bundling slot group 4 in FIG. 8) from the plurality of slots corresponding to the uplink information. Since this embodiment considers physical slots as the counting unit, slots (downlink slots in FIG. 8) that cannot be used for uplink transmission may be included when the bundling slots are counted. The target device performs, based on the configuration information sent by the target network device, frequency hopping transmission in units of 4 slots.

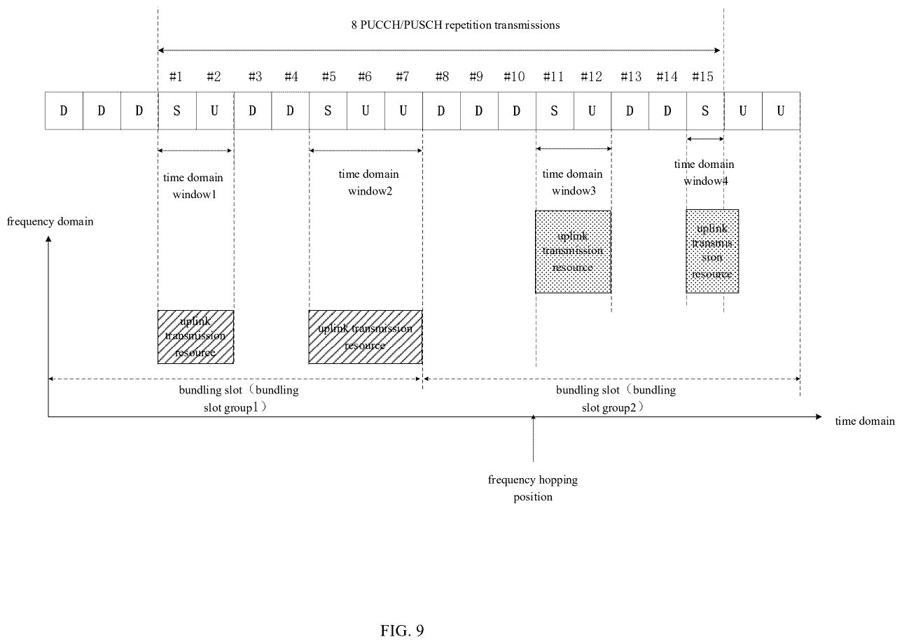

As shown in FIG. 9, in the TDD system, taking a 2.5 ms dual-period frame structure of “DDDSUDDSUU” as an example, the target device can determine time domain window 1, time domain window 2, time domain window 3, and time domain window 4 based on the time domain window configuration information sent by the target network device, and the target device maintains phase consistency and power consistency within the four windows, respectively. The network device explicitly configures the number of bundling slots (i.e., the target network device informs the target device of the size (e.g., the number of bundling slots or the time cycle of the bundling slots) of the bundling slots in each slot group by sending the control information), such as 10 physical slots, or configures the frequency hopping period, such as a frequency hopping period of 2.5 ms. The target device can divide, based on the slot size (e.g., the size of 10 physical slots) sent by the target network device, at least one bundling slot group (bundling slot group 1 and bundling slot group 2 in FIG. 9) from the plurality of slots corresponding to the uplink information. Since this embodiment considers physical slots as the counting unit, slots (downlink slots in FIG. 9) that cannot be used for uplink transmission may be included when the bundling slots are counted. The user performs, based on the configuration of the network device, frequency hopping transmission in units of 10 slots.

In the step S610, time domain position information for frequency hopping is determined according to the at least one bundling slot group, so that the target device performs frequency hopping transmission with bundling slot of the uplink information according to the time domain position information for frequency hopping and the frequency domain resource configuration information for frequency hopping.

In some embodiments, the target device performs the frequency hopping transmission with bundling slot based on the frequency domain resource configuration information for frequency hopping and the at least one bundling slot group, each bundling slot group corresponds to frequency domain resource configuration information of a frequency hopping, and the time domain position for frequency hopping is the starting position of the valid uplink slot of each bundling slot group. The target device maintains phase consistency and power consistency within each time domain window when performing the frequency hopping transmission with bundling slot.

In some embodiments, the at least one bundling slot group includes a target bundling slot group, which includes a first target slot and a second target slot. The first target slot is a first slot in the target bundling slot group, and the second target slot is the next slot after the first target slot. The first target slot is not used for uplink transmission of uplink information. Then the second target slot can be determined as the starting position of the valid uplink slot of the target bundling slot group.

As shown in FIG. 7, the starting position (i.e., the first slot in bundling slot group 2) of the first valid uplink slot in bundling slot group 2 can be used as the frequency hopping position of bundling slot group 2.

As shown in FIG. 8, the starting position (i.e., the first slot in bundling slot group 2) of the first valid uplink slot in bundling slot group 2 can be used as the frequency hopping position of bundling slot group 2, and the starting position (i.e., the third slot in bundling slot group 3) of the first valid uplink slot in bundling slot group 3 can be used as the frequency hopping position of bundling slot group 3, and so on.

In this method, the network device explicitly configures the number of bundling slots. The user does not perform frequency hopping within the number of bundling slots. When the count reaches the number of bundling slots, the user performs frequency hopping.

In some embodiments, the at least one bundling slot group includes a first bundling slot group and a second bundling slot group, and the frequency domain resource configuration information for frequency hopping includes first frequency domain resource configuration information and second frequency domain resource configuration information. Then, performing, by the target device, the frequency hopping transmission with bundling slot according to the frequency domain resource configuration information for frequency hopping and the at least one bundling slot group may include: the target device performs uplink information transmission in the first bundling slot group according to the first frequency domain resource configuration information; and the target device performs the uplink information transmission in the second bundling slot group according to the second frequency domain resource configuration information.

In some embodiments, the at least one bundling slot group further includes a third bundling slot group, and the frequency domain resource configuration information for frequency hopping further includes third frequency domain resource configuration information. Then, performing, by the target device, the frequency hopping transmission with bundling slot according to the frequency domain resource configuration information for frequency hopping and the at least one bundling slot group may further include: the target device performs the uplink information transmission in the third bundling slot group according to the third frequency domain resource configuration information.

In the technical solution provided in the embodiment, the plurality of slots corresponding to the uplink information are bundled into groups by the bundling slot configuration information, and then the frequency hopping transmission is performed on each group. The target network device can perform joint channel estimation for a common slot of a time domain window and a slot group, thereby improving uplink transmission performance.

In some embodiments, after the target device performs the frequency hopping transmission with bundling slot of the uplink information, the target network device receives the uplink information transmitted by the target device, and then performs joint channel estimation for the uplink information in combination with each bundling slot group, and then parses the uplink information.

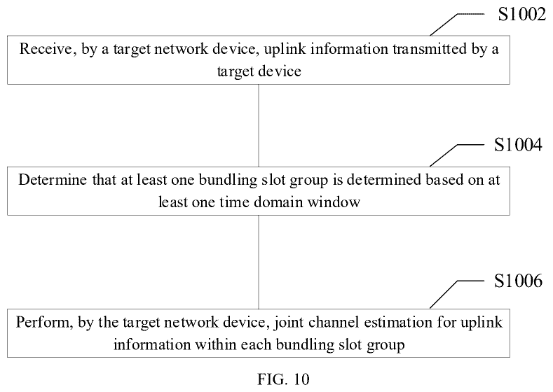

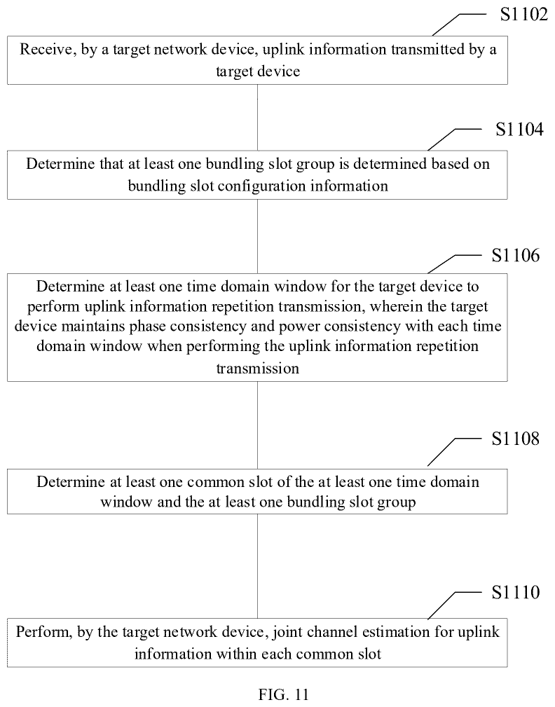

Specifically, the target network device can perform signal parsing and processing for the received uplink information through steps shown in FIG. 10 or FIG. 11.

FIG. 10 shows a flowchart of a method for signal parsing and processing according to an example embodiment.

Referring to FIG. 10, the method for signal parsing and processing may include steps S1002 to S1006.

In the step S1002, the target network device receives the uplink information transmitted by the target device.

In the step S1004, it is determined that at least one bundling slot group is determined based on at least one time domain window.

In the step S1006, the target network device performs joint channel estimation for uplink information in each bundling slot group.

As shown in FIG. 3, the target network device can perform joint channel estimation for uplink information within bundling slot group 1, and can also perform joint channel estimation for uplink information within bundling slot group 2.

As shown in FIG. 4 (or FIG. 5), the target network device can perform joint channel estimation for uplink information within bundling slot 1, within bundling slot group 2, and within bundling slot group 3.

In the technical solution provided in the embodiment, the target network device can perform joint channel estimation based on the time domain window, thereby improving uplink transmission performance.

FIG. 11 shows a flowchart of a method for signal parsing and processing according to an example embodiment. Referring to FIG. 11, the method for signal parsing and processing may include steps S1102 to S1106.

In the step S1102, the target network device receives the uplink information transmitted by the target device.

In the step S1104, it is determined that at least one bundling slot group is determined based on bundling slot configuration information.

In the step S1106, at least one time domain window for the target device to perform uplink information repetition transmission is determined, and the target device maintains phase consistency and power consistency within each time domain window when performing the uplink information repetition transmission.

In the step S1108, at least one common slot of the at least one time domain window and the at least one bundling slot group is determined.

In some embodiments, the at least one common slot may include one common slot or multiple common slots, which is not limited by the present disclosure. Each common slot may include one slot or multiple slots, which is not limited by the present disclosure.

As shown in FIG. 7, a common slot of time domain window 1 and bundling slot group 1 includes slots #1 to #4, and a common slot of time domain window 2 and bundling slot group 2 includes slots #6 to #8, and so on.

As shown in FIG. 8, a common slot of time domain window 1 and bundling slot group 1 includes slots #1 to #2, a common slot of time domain window 2 and bundling slot group 2 includes slots #5 to #7, a common slot of time domain window 3 and bundling slot group 3 is slots #11 to #12, and a common slot of time domain window 4 and bundling slot group 4 includes slot #15, and so on.

As shown in FIG. 9, a common slot of time domain window 1 and bundling slot group 1 includes slots #1 to #2, a common slot of time domain window 2 and bundling slot group 1 includes slots #5 to #7, a common slot of time domain window 3 and bundling slot group 2 includes slots #11 to #12, and a common slot of time domain window 4 and bundling slot group 2 includes slot #15, and so on.

In the step S1110, the target network device performs joint channel estimation for the uplink information in each common slot.

In some embodiments, the at least one time domain window may include a fourth time domain window (time domain window 1 in FIG. 9), the at least one bundling slot group includes a fourth bundling slot group (bundling slot group 1 in FIG. 9), and the at least one common slot includes a fourth common slot (e.g., common slot(s) composed of slots #1 to #2 in FIG. 9). The fourth common slot is the common slot(s) of the fourth time domain window and the fourth bundling slot group. Then, performing, by the target network device, joint channel estimation for each common slot may include: if it is determined that the number of slots in the fourth common slot is larger than 1, then joint channel estimation is performed for slots in the fourth common slot, and if it is determined that the number of slots in the fourth common slot is equal to 1, then channel estimation is separately performed for the slot in the fourth slot.

In some embodiments, the at least one time domain window includes a fifth time domain window (time domain window 2 in FIG. 9), the at least one common slot includes a fifth common slot (e.g., common slot(s) composed of slots #5 to #7 in FIG. 9), and the fifth common slot is the common slot(s) of the fifth time domain window and the fourth bundling slot group. Then, performing, by the target network device, joint channel estimation for each common slot may further includes: if it is determined that the number of slots in the fifth common slot is larger than 1, then joint channel estimation is performed for slots in the fifth common slot, and if it is determined that the number of slots in the fifth common slot is equal to 1, then channel estimation is separately performed for the slot in the fifth slot.

In some embodiments, the at least one bundling slot group includes a fifth bundling slot group, the at least one common slot includes a sixth common slot, and the sixth common slot is the common slot(s) of the fourth time domain window and the fifth bundling slot group. Then, performing, by the target network device, joint channel estimation for each common slot may include: if it is determined that the number of slots in the sixth common slot is larger than 1, then joint channel estimation is performed for slots in the sixth common slot, and if it is determined that the number of slots in the sixth common slot is equal to 1, then channel estimation is separately performed for the slot in the sixth slot.

Specifically, as shown in FIG. 7, the target terminal can perform frequency hopping transmission in units of four slots, depending on the configuration of the target network device. It can be observed that uplink slots #1 to #4 are located within the same time domain window 1, maintaining phase and power consistency. The target network device can perform joint channel estimation for uplink slots #1 to #4. Note that frequency hopping occurs in uplink slot #5. Due to the frequency hopping, phase or power consistency is disrupted. Therefore, the window actually available for joint channel estimation changes to time domain window 1′, and the target network device cannot perform joint channel estimation for uplink slot #5 together with uplink slots #1 to #4. For uplink slots #6 to #8, it can be observed that they are located within the same time domain window 2, maintaining phase and power consistency. The network device can perform joint channel estimation for uplink slots #6 to #8. However, since uplink slots #5 and uplink slots #6 to #8 are located in different time domain windows, the network device cannot perform joint channel estimation for uplink slot #5 together with uplink slots #6 to #8. Finally, uplink slot #5 transmits uplink information normally and the joint channel estimation is not performed for uplink slot #5 with other slots.

As shown in FIG. 8, uplink slots #1 to #2 belong to the same time domain window, uplink slots #5 to #7 belong to the same time domain window, and uplink slots #11 to #12 belong to the same time domain window, and phase consistency and power consistency can be respectively maintained within respective time domain windows, and the network device can perform joint channel estimation for them respectively.

As shown in FIG. 9, uplink slots #1 to #2 belong to the same time domain window, uplink slots #5 to #7 belong to the same time domain window, and uplink slots #11 to #12 belong to the same time domain window, and phase consistency and power consistency can be respectively maintained within respective time domain windows, and the target network device can perform joint channel estimation for them respectively. However, for uplink slots #1 to #2 and uplink slots #5 to #7, the target network device does not perform joint channel estimation for these five slots together, since they belong to different time domain windows. Similarly, for slots #5 to #7 and slots #11 to #12, the network device cannot perform joint channel estimation for these five slots together, since they belong to different time domain windows.

In the technical solution provided in the embodiment, the target network device can perform joint channel estimation based on the time domain window, thereby improving uplink transmission performance.

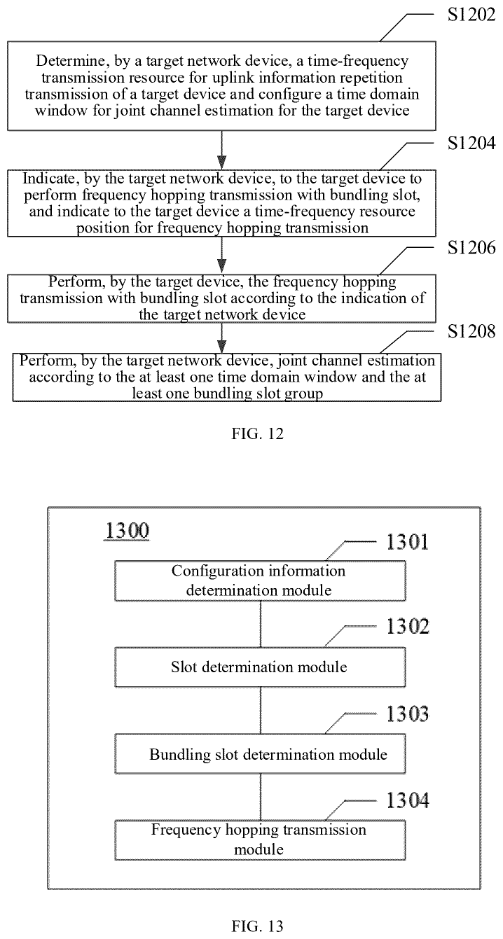

FIG. 12 shows a flowchart of a frequency hopping transmission method according to an example embodiment.

In step S1202, the target network device determines a time-frequency transmission resource for uplink information repetition transmission of the target device and configures a time domain window for joint channel estimation for the target device.

In some embodiments, the target network device may configure and send a relevant time-frequency transmission resource for uplink information repetition transmission of the target device, and configure the time domain window for joint channel estimation.

The so-called “time domain window” may mean that the target network device expects the target device to maintain phase consistency and power consistency when performing the uplink transmission in this time domain window, thereby enabling the target network device to perform joint channel estimation for the uplink transmission information received within the time domain window.

In step S1204, the target network device indicates to the target device to perform frequency hopping transmission with bundling slot, and indicates to the target device a time-frequency resource position for frequency hopping transmission.

In some embodiments, the target network device may indicate, through control information, to the target device to perform the frequency hopping transmission with bundling slot, and indicate to the target device the time-frequency resource position for frequency hopping transmission.

In some embodiments, the target network device may only indicate to the target device the need of performing the frequency hopping transmission with bundling slot and the frequency domain resource position for the frequency hopping transmission, so that the target device can determine, according to the time domain window, at least one bundling slot group from the plurality of slots corresponding to the uplink information repetition transmission, so as to perform the frequency hopping transmission with bundling slot according to the bundling slot and the frequency domain resource for frequency hopping transmission sent by the target network device.

In some embodiments, the target network device may indicate to the target device the need of performing the frequency hopping transmission with bundling slot and also indicate slot configuration information (including the slot size) for the target device to perform frequency hopping transmission, so that the target device can determine, according to the slot configuration information, at least one bundling slot group from the plurality of slots corresponding to the uplink information repetition transmission, so as to perform the frequency hopping transmission with bundling slot according to the bundling slot and the frequency domain resource for frequency hopping transmission sent by the target network device.

In step S1206, the target device performs the frequency hopping transmission with bundling slot according to the indication of the target network device.

In some embodiments, the target device may determine, according to the time domain window, the at least one bundling slot group from the plurality of slots corresponding to the uplink information repetition transmission, and then perform the frequency hopping transmission with bundling slot according to the bundling slot and the frequency domain resource for frequency hopping transmission sent by the target network device.

In some embodiments, the target device may determine, based on the slot configuration information sent by the target network device, the at least one bundling slot group from the plurality of slots corresponding to the uplink information repetition transmission, and then perform the frequency hopping transmission with bundling slot according to the bundling slot and the frequency domain resource for frequency hopping transmission sent by the target network device.

In the step S1208, the target network device performs joint channel estimation.

In some embodiments, the target network device receives uplink information transmitted by the target device, and then performs joint channel estimation for the uplink information in combination with each bundling slot group, and in turn parses the uplink information.

If the at least one bundling slot group is determined based on the at least one time domain window, the target network device performs joint channel estimation for uplink information in each bundling slot group.

If the at least one bundling slot group is determined based on the bundling slot configuration information, then the at least one time domain window for the target device to perform the uplink information repetition transmission is determined, and the target device maintains phase consistency and power consistency within each time domain window when performing the uplink information repetition transmission. At least one common slot of the at least one time domain window and the at least one bundling slot group is determined, and the target network device performs joint channel estimation for uplink information in each common slot.

Through the method of the present disclosure, several slots used for PUSCH/PUCCH repetition transmission are bundled, enabling frequency hopping transmission to be performed for them together. In addition, joint channel estimation is performed in the common slot of these bundling slots with the time domain window, thereby improving the transmission performance of PUSCH and PUCCH.

FIG. 13 shows a block diagram of a data transmission apparatus according to an example embodiment. Referring to FIG. 13, the data transmission apparatus 1300 provided in the embodiment of the present disclosure may include: a configuration information determination module 1301, a slot determination module 1302, a bundling slot determination module 1303, and a frequency hopping transmission module 1304.

The configuration information determination module 1301 is configured to determine time domain resource configuration information for a target device to perform uplink information repetition transmission and frequency domain resource configuration information for frequency hopping. The slot determination module 1302 is configured to determine, according to the time domain resource configuration information, a plurality of slots corresponding to the uplink information repetition transmission of the target device. The bundling slot determination module 1303 is configured to determine at least one bundling slot group from the plurality of slots, wherein each bundling slot group includes at least one slot. The frequency hopping transmission module 1304 is configured to determine time domain position information for frequency hopping according to the at least one bundling slot group, to perform, by the target device, frequency hopping transmission with bundling slot of the uplink information according to the time domain position information for frequency hopping and the frequency domain resource configuration information for frequency hopping.

In some embodiments, the bundling slot determination module 1303 may include a time domain window determination sub-module and a first bundling slot determination sub-module.

The time domain window determination sub-module can be configured to determine at least one time domain window for the target device to perform the uplink information repetition transmission, to perform, by a target network device, joint channel estimation for the uplink information transmitted within each time domain window, wherein each time domain window includes at least one slot. The first bundling slot determination sub-module can be configured to determine, according to at least one slot within the at least one time domain window, the at least one bundling slot group, wherein at least one slot within one time domain window forms a bundling slot group.

In some embodiments, the bundling slot determination module 1303 may include a bundling slot configuration information determination sub-module and a second bundling slot determination sub-module.

The bundling slot configuration information determination sub-module can be configured to determine bundling slot configuration information for the target device to perform the uplink information repetition transmission, wherein the bundling slot configuration information includes a bundling slot size. The second bundling slot determination sub-module can be configured to divide, according to the bundling slot configuration information, the plurality of slots into the at least one bundling slot group.

In some embodiments, the frequency hopping transmission module 1304 may include: a bundling frequency hopping transmission sub-module.

The bundling frequency hopping transmission sub-module can be used by the target device to perform the frequency hopping transmission with bundling slot according to the frequency domain resource configuration information for frequency hopping and the at least one bundling slot group, wherein each bundling slot group corresponds to frequency domain resource configuration information of a frequency hopping, and a time domain position for frequency hopping is a starting position of a valid uplink slot of each bundling slot group. Phase consistency and power consistency are maintained within each time domain window by the target device when performing the frequency hopping transmission with bundling slot.

In some embodiments, the at least one bundling slot group includes a target bundling slot group, the target bundling slot group includes a first target slot and a second target slot, the first target slot is a first slot in the target bundling slot group, the second target slot is a next slot after the first target slot, and the first target slot is not used for uplink transmission of the uplink information. The data transmission apparatus 1300 may include: a starting position determination sub-module.

The starting position determination sub-module can be configured to determine the second target slot as a starting position of a valid uplink slot of the target bundling slot group.

In some embodiments, the at least one bundling slot group includes a first bundling slot group and a second bundling slot group, and the frequency domain resource configuration information for frequency hopping includes first frequency domain resource configuration information and second frequency domain resource configuration information. The bundling frequency hopping transmission sub-module may include first bundling slot group frequency hopping transmission and second bundling slot group frequency hopping transmission.

The first bundling slot group frequency hopping transmission can be used by the target device to perform uplink information transmission within the first bundling slot group according to the first frequency domain resource configuration information, and the second bundling slot group frequency hopping transmission can be used by the target device to perform the uplink information transmission within the second bundling slot group according to the second frequency domain resource configuration information.

In some embodiments, the at least one bundling slot group further includes a third bundling slot group, and the frequency domain resource configuration information for frequency hopping further includes third frequency domain resource configuration information. The bundling frequency hopping transmission sub-module may further include third bundling slot group frequency hopping transmission.

The third bundling slot group frequency hopping transmission can be used by the target device to perform the uplink information transmission within the third bundling slot group according to the third frequency domain resource configuration information.

In some embodiments, the data transmission apparatus may further include an uplink information receiving module and a joint channel estimation module.

The uplink information receiving module can be used by the target network device to receive the uplink information transmitted by the target device. The joint channel estimation module can be used by the target network device to perform joint channel estimation for the uplink information in combination with each bundling slot group, to parse the uplink information.

In some embodiments, the joint channel estimation module may include: a first determination sub-module for bundling slot generation method and a first joint channel estimation sub-module.

The first determination sub-module for the bundling slot generation method can be configured to determine that the at least one bundling slot group is determined according to at least one time domain window. The first joint channel estimation sub-module can be used by the target network device to perform the joint channel estimation for the uplink information in each bundling slot group.

In some embodiments, the joint channel estimation module may include: a second determination sub-module for bundling slot generation method, at least one time domain window determination sub-module, a common slot determination sub-module, and a second joint channel estimation sub-module.

The second determination sub-module for the bundling slot generation method can be configured to determine that the at least one bundling slot group is determined according to bundling slot configuration information. The at least one time domain window determination sub-module can be configured to determine at least one time domain window for the target device to perform the uplink information repetition transmission, wherein phase consistency and power consistency are maintained within each time domain window by the target device when performing the uplink information repetition transmission. The common slot determination sub-module can be configured to determine at least one common slot of the at least one time domain window and the at least one bundling slot group. The second joint channel estimation sub-module can be used by the target network device to perform the joint channel estimation for the uplink information in each common slot.

In some embodiments, the at least one time domain window includes a fourth time domain window, the at least one bundling slot group includes a fourth bundling slot group, the at least one common slot includes a fourth common slot, and the fourth common slot is the common slot(s) of the fourth time domain window and the fourth bundling slot group. The second joint channel estimation sub-module may include a first determination unit for the number of common slots in the fourth common slot and a second determination unit for the number of common slots in the fourth common slot.

The first determination unit for the number of common slots in the fourth common slot can be configured to determine that the number of slots in the fourth common slot is larger than 1, and perform the joint channel estimation for slots in the fourth common slot. The second determination unit for the number of common slots in the fourth common slot can be configured to determine that the number of slots in the fourth common slot is equal to 1, and perform separate channel estimation for a slot in the fourth common slot.

In some embodiments, the at least one time domain window includes a fifth time domain window, the at least one common slot includes a fifth common slot, and the fifth common slot is the common slot(s) of the fifth time domain window and the fourth bundling slot group. The second joint channel estimation sub-module may further include: a first determination unit for the number of common slots in the fifth common slot and a second determination unit for the number of common slots in the fifth common slot.

The first determination unit for the number of common slots in the fifth common slot can be configured to determine that the number of slots in the fifth common slot is larger than 1, and perform the joint channel estimation for slots in the fifth common slot. The second determination unit for the number of common slots in the fifth common slot can be configured to determine that the number of slots in the fifth common slot is equal to 1, and perform separate channel estimation for a slot in the fifth common slot.

In some embodiments, the at least one bundling slot group includes a fifth bundling slot group, the at least one common slot includes a sixth common slot, and the sixth common slot is the common slot(s) of the fourth time domain window and the fifth bundling slot group. The second joint channel estimation sub-module may further include: a first determination unit for the number of common slots in the sixth common slot and a second determination unit for the number of common slots in the sixth common slot.

The first determination unit for the number of common slots in the sixth common slot can be configured to determine that the number of slots in the sixth common slot is larger than 1, and perform the joint channel estimation for slots in the sixth common slot. The second determination unit for the number of common slots in the sixth common slot can be configured to determine that the number of slots in the sixth common slot is equal to 1, and perform separate channel estimation for a slot in the sixth common slot.

In some embodiments, the bundling slot size is the number of physical slots, the number of uplink slots, or a time cycle. The second bundling slot determination sub-module includes: a physical slot division unit, an uplink slot division unit, or a time cycle division unit.

The physical slot division unit can be configured to divide, according to the number of physical slots, the plurality of slots into the at least one bundling slot group. The uplink slot division unit can be configured to divide, according to the number of uplink slots, the plurality of slots into the at least one bundling slot group. The time cycle division unit can be configured to divide, according to the time cycle, the plurality of slots into the at least one bundling slot group.

In some embodiments, the uplink information is uplink data information or uplink control information, the uplink data information is carried by PUSCH, and the uplink control information is carried by PUCCH or PUSCH. Since various functions of the apparatus 1300 have been described in detail in their corresponding method embodiments, they will not be repeated here.

The modules and/or sub-modules and/or units described in embodiments of the present disclosure can be implemented in software or hardware. The described modules and/or sub-modules and/or units can also be provided in a processor. In some cases, names of these modules and/or sub-modules and/or units do not constitute a limitation on the module and/or sub-module and/or unit itself.

The flowcharts and block diagram in the accompanying drawings illustrate the possible architectures, functions, and operations of systems, methods, and computer program products according to various embodiments of the present disclosure. In this regard, each block in a flowchart or block diagram may represent a module, program segment, or a part of code that contains one or more executable instructions for implementing a specified logic function. It should also be noted that in some alternative implementations, functions indicated in the block may also occur in a different sequence than those indicated in the drawings. For example, two contiguous blocks may actually be executed in substantially parallel, or be executed in reverse sequence sometimes, depending on the function involved. It should also be noted that each block in the block diagram or flowchart and the combination of the blocks in the block diagram or flow chart may be implemented by a dedicated hardware based system that performs a specified function or operation, or by a combination of dedicated hardware and computer instructions.

Furthermore, the above accompanying drawings are merely illustrative of the processes included in the method according to example embodiments of the present disclosure and are not intended to be limiting. It is readily understood that the processes shown in the above accompanying drawings do not indicate or limit the temporal order of these processes. Additionally, it is readily understood that these processes may be executed synchronously or asynchronously, for example, in multiple modules.

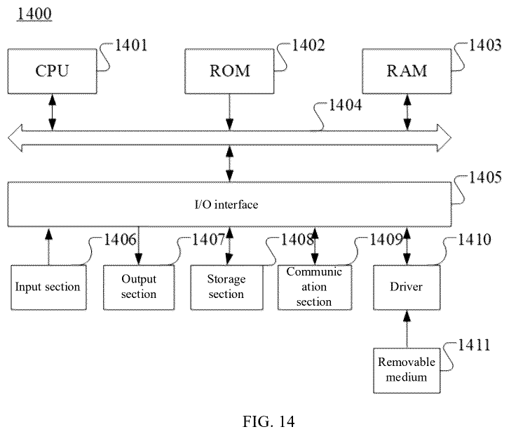

FIG. 14 shows a schematic structural diagram of an electronic device suitable for implementing embodiments of the present disclosure. It should be noted that the electronic device 1400 shown in FIG. 14 is merely an example and should not impose any limitations on the functionality and scope of use of the embodiments of the present disclosure.

As shown in FIG. 14, the electronic device 1400 includes a central processing unit (CPU) 1401 that may perform various appropriate actions and processes according to a program stored in a read only memory (ROM) 1402 or a program loaded from a storage section 1408 into a random access memory (RAM) 1403. In RAM 1403, various programs and data required for electronic device 1400 operations are also stored. CPU 1401, ROM 1402, and RAM 1403 are connected to each other through a bus 1404. An input/output (I/O) interface 1405 is also connected to the bus 1404.

The following components are connected to the I/O interface 1405: an input section 1406 including a keyboard, a mouse, and the like, an output section 1407 including a cathode ray tube (CRT), a liquid crystal display (LCD) and the like as well as a speaker, and the like, a storage section 1408 including a hard disk, and the like, and a communication section 1409 including a network interface card such as a LAN card, a modem, and the like. The communication section 1409 performs communication processing via a network such as the Internet. A driver 1410 is also connected to I/O interface 1405 as required. A removable medium 1411, such as a magnetic disk, an optical disk, a magneto-optical disk, a semiconductor memory, and the like, is installed on the driver 1410 as required, such that a computer program read from the removable medium 1411 is loaded into the storage section 1408 as required.

Specifically, according to an embodiment of the present disclosure, process described above with reference to a flowchart may be implemented as a computer software program. For example, embodiments of the present disclosure include a computer program product including a computer program carried on a computer-readable storage medium, and the computer program including program code for executing the method shown in the flowchart. In such an embodiment, the computer program may be downloaded and installed from the network through the communication section 1409, and/or installed from the removable medium 1411. When the computer program is executed by the central processing unit (CPU) 1401, the above functions defined in the system of the present disclosure are executed.

It should be noted that the computer-readable storage medium shown in the present disclosure may be a computer-readable signal medium, a computer-readable storage medium, or any combination of the two. The computer-readable storage medium may be, for example, but is not limited to, an electronic, magnetic, optical, electromagnetic, infrared, or semiconductor system, device, or apparatus, or any combination thereof. More specific examples of computer readable storage media may include, but are not limited to: electrical connection with one or a plurality of wires, portable disk, hard disk, random access memory (RAM), read-only memory (ROM), erasable programmable read-only memory (EPROM or flash memory), optical fiber, portable compact disc read-only memory (CD-ROM), optical storage apparatus, magnetic storage apparatus, or any suitable combination thereof. In the present disclosure, a computer-readable storage medium may be any tangible medium containing or storing a program that may be used by or in combination with an instruction execution system, device, or apparatus. In the present disclosure, the computer-readable signal medium may include a data signal in baseband or propagated as part of a carrier wave, which carries readable program codes. Such a propagated data signal may have many forms, including but not limited to electromagnetic signals, optical signals, or any suitable combination of the above. The computer-readable signal medium may also be any computer-readable storage medium other than a computer-readable storage medium, and the computer-readable storage medium may send, propagate, or transmit a program that is used by an instruction execution system, device, or apparatus, or that is used in combination with an instruction execution system, device, or apparatus. The program code contained on the computer-readable storage medium may be transmitted by any suitable medium, including but not limited to: wireless, wire, optical cable, RF, etc., or any suitable combination of the above.

In another aspect, the present disclosure further provides a computer-readable storage medium, which may be included in the device described in the above embodiments; or may exist independently and not assembled into the device. The computer-readable storage medium carries one or more programs that, when executed by the device, enable the device to implement functions, including: determining time domain resource configuration information for a target device to perform uplink information repetition transmission and frequency domain resource configuration information for frequency hopping; determining, according to the time domain resource configuration information, a plurality of slots corresponding to the uplink information repetition transmission of the target device; determining at least one bundling slot group from the plurality of slots, wherein each bundling slot group includes at least one slot; and determining time domain position information for frequency hopping according to the at least one bundling slot group, to perform, by the target device, frequency hopping transmission with bundling slot of the uplink information according to the time domain position information for frequency hopping and the frequency domain resource configuration information for frequency hopping.

According to an aspect of the present disclosure, there is provided a computer program product or a computer program including computer instructions stored in a computer-readable storage medium. A processor of a computer device reads the computer instructions from the computer-readable storage medium and executes the computer instructions, causing the computer device to perform the methods provided in various optional implementations of the above embodiments.

Through the description of the above embodiments, those skilled in the art will readily understand that the example embodiments described herein may be implemented by software or by a combination of software with necessary hardware. Therefore, the technical solutions according to embodiments of the present disclosure may be embodied in the form of a software product, which may be stored in a non-volatile or non-transitory storage medium (which may be a CD-ROM, a USB flash drive, a mobile hard disk, etc.). A number of instructions are included to cause a computing device (which may be a personal computer, a server, a mobile terminal, or a smart device, etc.) to perform the methods in accordance with the embodiments of the present disclosure, such as one or more steps shown in FIG. 1, 2, 6, 10, 11, or 12.

Other embodiments of the present disclosure will be apparent to those skilled in the art from consideration of the specification and practice of the present disclosure disclosed herein. The present disclosure is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

It should be understood that the present disclosure is not limited to the precise structures that have been described above and shown in the drawings, or implementations. Conversely, the present disclosure is meant to encompass various modifications and equivalent arrangements that fall within the spirit and scope of the appended claims.

1-19. (canceled)

20. A data transmission method, comprising:
determining time domain resource configuration information and frequency domain resource configuration information for frequency hopping for uplink information repetition transmission of a target device;
determining a plurality of slots corresponding to the uplink information repetition transmission of the target device based on the time domain resource configuration information;
determining bundling slot configuration information, wherein the bundling slot configuration information comprises a bundling slot size, and the bundling slot size is a number of physical slots, or a number of uplink slots, or a time cycle;
dividing the plurality of slots into at least one bundling slot group based on the bundling slot configuration information, wherein each bundling slot group comprises at least one slot;
determining a time domain window, the target device maintaining phase continuity and power consistency within the time domain window, wherein each time domain window comprises at least one slot;
determining a common slot of the time domain window and the bundling slot group; and
performing, by the target device, frequency hopping transmission with bundling slot of the uplink information based on the bundling slot group, the frequency domain resource configuration information for frequency hopping, and the common slot.

21. The method according to claim 20, wherein the method further comprises: determining, according to at least one slot within the at least one time domain window, the at least one bundling slot group, wherein at least one slot within one time domain window forms a bundling slot group.

22. The method according to claim 20, wherein the method further comprises: determining time domain position information for frequency hopping according to the at least one bundling slot group, wherein a time domain position for frequency hopping is the starting position of a valid uplink slot of each bundling slot group.

23. The method according to claim 22, wherein the at least one bundling slot group comprises a target bundling slot group, the target bundling slot group comprises a first target slot and a second target slot, the first target slot is the first slot in the target bundling slot group, the second target slot is the next slot after the first target slot, and the first target slot is not used for uplink transmission of the uplink information;
wherein the method comprises: determining the second target slot as a starting position of a valid uplink slot of the target bundling slot group.

24. The method according to claim 22, wherein the at least one bundling slot group comprises a first bundling slot group and a second bundling slot group, and the frequency domain resource configuration information for frequency hopping comprises first frequency domain resource configuration information and second frequency domain resource configuration information;
wherein performing, by the target device, the frequency hopping transmission with bundling slot according to the frequency domain resource configuration information for frequency hopping and the at least one bundling slot group comprises:
performing, by the target device, uplink information transmission within the first bundling slot group according to the first frequency domain resource configuration information; and
performing, by the target device, the uplink information transmission within the second bundling slot group according to the second frequency domain resource configuration information.

25. The method according to claim 24, wherein the at least one bundling slot group further comprises a third bundling slot group, and the frequency domain resource configuration information for frequency hopping further comprises third frequency domain resource configuration information;
wherein performing, by the target device, the frequency hopping transmission with bundling slot according to the frequency domain resource configuration information for frequency hopping and the at least one bundling slot group further comprises:
performing, by the target device, the uplink information transmission within the third bundling slot group according to the third frequency domain resource configuration information.

26. The method according to claim 20, wherein the method further comprises:
receiving, by a target network device, the uplink information transmitted by the target device; and
performing, by the target network device, joint channel estimation for the uplink information in combination with each bundling slot group, to parse the uplink information.

27. The method according to claim 26, wherein performing, by the target network device, the joint channel estimation for the uplink information in combination with each bundling slot group comprises:
determining that the at least one bundling slot group is determined according to at least one time domain window; and
performing, by the target network device, the joint channel estimation for the uplink information in each bundling slot group.

28. The method according to claim 26, wherein performing, by the target network device, the joint channel estimation for the uplink information in combination with each bundling slot group comprises:
determining that the at least one bundling slot group is determined according to bundling slot configuration information;
determining at least one time domain window for the target device to perform the uplink information repetition transmission, wherein phase consistency and power consistency are maintained within each time domain window by the target device when performing the uplink information repetition transmission;
determining at least one common slot of the at least one time domain window and the at least one bundling slot group; and
performing, by the target network device, the joint channel estimation for the uplink information in each common slot.

29. The method according to claim 28, wherein the at least one time domain window comprises a fourth time domain window, the at least one bundling slot group comprises a fourth bundling slot group, the at least one common slot comprises a fourth common slot, and the fourth common slot is the common slot(s) of the fourth time domain window and the fourth bundling slot group;
wherein performing, by the target network device, the joint channel estimation for the uplink information in each common slot comprises:
determining that the number of slots in the fourth common slot is larger than 1, and performing the joint channel estimation for slots in the fourth common slot; and
determining that the number of slots in the fourth common slot is equal to 1, and performing separate channel estimation for the slot in the fourth common slot.

30. The method according to claim 29, wherein the at least one time domain window comprises a fifth time domain window, the at least one common slot comprises a fifth common slot, and the fifth common slot is the common slot(s) of the fifth time domain window and the fourth bundling slot group;
wherein performing, by the target network device, the joint channel estimation for the uplink information in each common slot further comprises:
determining that the number of slots in the fifth common slot is larger than 1, and performing the joint channel estimation for slots in the fifth common slot; and
determining that the number of slots in the fifth common slot is equal to 1, and performing separate channel estimation for the slot in the fifth common slot.

31. The method according to claim 29, wherein the at least one bundling slot group comprises a fifth bundling slot group, the at least one common slot comprises a sixth common slot, and the sixth common slot is the common slot(s) of the fourth time domain window and the fifth bundling slot group;
wherein performing, by the target network device, the joint channel estimation for the uplink information in each common slot comprises:
determining that the number of slots in the sixth common slot is larger than 1, and performing the joint channel estimation for slots in the sixth common slot; and
determining that the number of slots in the sixth common slot is equal to 1, and performing separate channel estimation for the slot in the sixth common slot.

32. The method according to claim 22, wherein dividing, according to the bundling slot configuration information, the plurality of slots into the at least one bundling slot group comprises:
dividing, according to the number of physical slots, the plurality of slots into the at least one bundling slot group;
dividing, according to the number of uplink slots, the plurality of slots into the at least one bundling slot group; or,
dividing, according to the time cycle, the plurality of slots into the at least one bundling slot group.

33. The method according to claim 20, wherein the uplink information is uplink data information or uplink control information, the uplink data information is carried by PUSCH, and the uplink control information is carried by PUCCH or PUSCH.

34. A data transmission apparatus, comprising:
a configuration information determination module, configured to determine time domain resource configuration information and frequency domain resource configuration information for frequency hopping for uplink information repetition transmission of a target device;
a slot determination module, configured to determine a plurality of slots corresponding to the uplink information repetition transmission of the target device based on the time domain resource configuration information;
a bundling slot determination module, configured to determine bundling slot configuration information, wherein the bundling slot configuration information comprises a bundling slot size, and the bundling slot size is a number of physical slots, or a number of uplink slots, or a time cycle, and divide the plurality of slots into at least one bundling slot group based on the bundling slot configuration information, wherein each bundling slot group comprises at least one slot; and
a frequency hopping transmission module, configured to determine a time domain window, the target device maintaining phase continuity and power consistency within the time domain window, wherein each time domain window comprises at least one slot, determine a common slot of the time domain window and the bundling slot group; and perform frequency hopping transmission with bundling slot of the uplink information based on the bundling slot group, the frequency domain resource configuration information for frequency hopping, and the common slot.

35. An electronic device, comprising:
a memory; and
a processor coupled to the memory, wherein the processor is configured to execute, based on instructions stored in the memory, the data transmission method according to claim 20.

36. A computer-readable storage medium having a program stored thereon, wherein the program, when executed by a processor, implements the data transmission method according to claim 20.
